(19) United States
(12) Patent Application Publication
(10) Pub. No.: US 2026/0364943 A1
(43) Pub. Date: Nov. 19, 2026

(54) CLEANING DEVICE AND CLEANING METHOD FOR NOZZLE PLACEMENT SURFACE

(71) Applicant: KYOCERA CORPORATION, Kyoto-shi, Kyoto (JP)

(72) Inventors: Tomoya HOTANI, Kimino-cho, Kaisou-gun, Wakayama (JP); Masaaki MARUTA, Matsubara-shi, Osaka (JP)

(21) Appl. No.: 19/142,633

(22) PCT Filed: Mar. 4, 2024
(86) PCT No.: PCT/JP2024/008148

§ 371 Date: Jun. 24, 2025

(30) Foreign Application Priority Data
Mar. 31, 2023 (JP) 2023-057693

(51) Int. Cl. B41J 2/165; B41J 11/00

(52) U.S. Cl. CPC B41J 2/16552; B41J 11/0015; B41J 2002/16558

(57) ABSTRACT

A cleaning device for a nozzle placement surface on which a nozzle to eject a liquid is placed includes a fabric wiper, a mover, and an orientation switcher. The fabric wiper includes a feeder portion and a takeup portion for a fabric sheet, and a wipe portion defined by a portion of the fabric sheet between the feeder portion and the takeup portion. The mover moves the fabric wiper between a cleaning position at which the fabric wiper cleans the nozzle placement surface and a retracted position at which the fabric wiper does not clean the nozzle placement surface. The orientation switcher switches an orientation of the wipe portion between a cleaning orientation in which the wipe portion is in contact with the nozzle placement surface at the cleaning position and a retracted orientation in which the wipe portion is separate from the nozzle placement surface at the retracted position.

### CROSS-REFERENCE TO RELATED APPLICATION

The present application is a National Phase of International Application No. PCT/JP2024/008148 filed Mar. 4, 2024, which claims priority to Japanese Patent Application No. 2023-057693, filed on Mar. 31, 2023.

### TECHNICAL FIELD

The present disclosure relates to a cleaning device and a cleaning method for a nozzle placement surface on which a nozzle to eject a liquid is placed.

### BACKGROUND OF INVENTION

Inkjet recording apparatuses such as inkjet printers include heads each including many nozzles for ejecting ink or predetermined treatment liquids. Such heads involve cleaning of a nozzle placement surface at predetermined intervals to, for example, unclog the nozzles and remove contamination from the surface. Patent Literature 1 describes an inkjet printer that cleans the nozzle placement surface by pressing a cleaning sheet supported by a presser against the nozzle placement surface.

### CITATION LIST

### Patent Literature

Patent Literature 1: Japanese Unexamined Patent Application Publication No. 2011-73145

### SUMMARY

In one aspect of the present disclosure, a cleaning device is for a nozzle placement surface on which a nozzle to eject a liquid is placed. The cleaning device includes a fabric wiper, a mover, and an orientation switcher. The fabric wiper includes a feeder portion and a takeup portion for a fabric sheet. The fabric wiper further includes a wipe portion defined by a portion of the fabric sheet between the feeder portion and the takeup portion. The mover moves the fabric wiper between a cleaning position at which the fabric wiper cleans the nozzle placement surface and a retracted position at which the fabric wiper does not clean the nozzle placement surface. The orientation switcher switches an orientation of the wipe portion between a cleaning orientation in which the wipe portion is in contact with the nozzle placement surface at the cleaning position and a retracted orientation in which the wipe portion is separate from the nozzle placement surface at the retracted position.

In another aspect of the present disclosure, a cleaning method is for a nozzle placement surface on which a nozzle to eject a liquid is placed. The cleaning method includes defining a wipe portion, separating the wipe portion from a nozzle placement surface, and placing the wipe portion in contact with the nozzle placement surface. The defining the wipe portion includes defining the wipe portion between a feeder portion and a takeup portion for a fabric sheet. The wipe portion is defined by a portion of the fabric sheet. The separating the wipe portion from the nozzle placement surface includes separating the wipe portion from the nozzle placement surface to place the wipe portion in a standby state when the nozzle placement surface is not to be cleaned. The placing the wipe portion in contact with the nozzle placement surface includes placing the wipe portion in contact with the nozzle placement surface for cleaning when the nozzle placement surface is to be cleaned.

### BRIEF DESCRIPTION OF THE DRAWINGS

FIG. 1 is a perspective view of an inkjet printer in one embodiment of the present disclosure, illustrating the overall structure.

FIG. 2 is a cross-sectional view taken along line II-II in FIG. 1, additionally illustrating a dryer.

FIG. 3 is an enlarged perspective view of a carriage illustrated in FIG. 1.

FIG. 4 is a perspective view of a frame of the inkjet printer, with the carriage moved to a fabric wipe area.

FIG. 5 is a perspective view of a nozzle placement surface of the carriage, cleaned with a fabric wiper.

FIG. 6 is a left side view of a fabric wipe device.

FIG. 7 is a right side view of the fabric wipe device.

FIG. 8 is a front view of the fabric wipe device.

FIG. 9 is a side view of a mover.

FIG. 10 is a perspective view of the fabric wiper.

FIG. 11 is a perspective view of the fabric wiper as viewed in a direction opposite the direction in which the fabric wiper is viewed in FIG. 10.

FIG. 12 is a left side view of the fabric wipe device, with the fabric wiper at a cleaning position.

FIG. 13 is a right side view of the fabric wipe device, with the fabric wiper at the cleaning position.

FIG. 14 is a block diagram of the inkjet printer partially illustrating its control configuration.

FIG. 15 is a plan view of the nozzle placement surface, describing a cleaning sequence for a fabric wipe.

FIG. 16A is a left side view of a fabric wipe device in a variation of the embodiment.

FIG. 16B is a right side view of the fabric wipe device in the variation of the embodiment.

FIG. 17A is a left side view of the fabric wipe device in the variation of the embodiment, with a fabric wiper at a cleaning position.

FIG. 17B is a right side view of the fabric wipe device in the variation of the embodiment, with the fabric wiper at the cleaning position.

### DESCRIPTION OF EMBODIMENTS

One embodiment of the present disclosure will now be described with reference to the drawings. In the present embodiment, a cleaning device and a cleaning method for a nozzle placement surface according to one or more embodiments of the present disclosure are used in, for example, an inkjet printer including ink heads that eject ink for forming images on a wide and elongated recording medium. In the present embodiment, the inkjet printer may be used for digital textile printing to print images such as letters or patterns on a recording medium including a textile such as woven fabric or knitted fabric by inkjet printing. In one or more embodiments of the present disclosure, the cleaning device and the cleaning method may also be used for printing various images by inkjet printing on a recording medium such as a paper sheet or a resin sheet.

### Overall Structure of Inkjet Printer

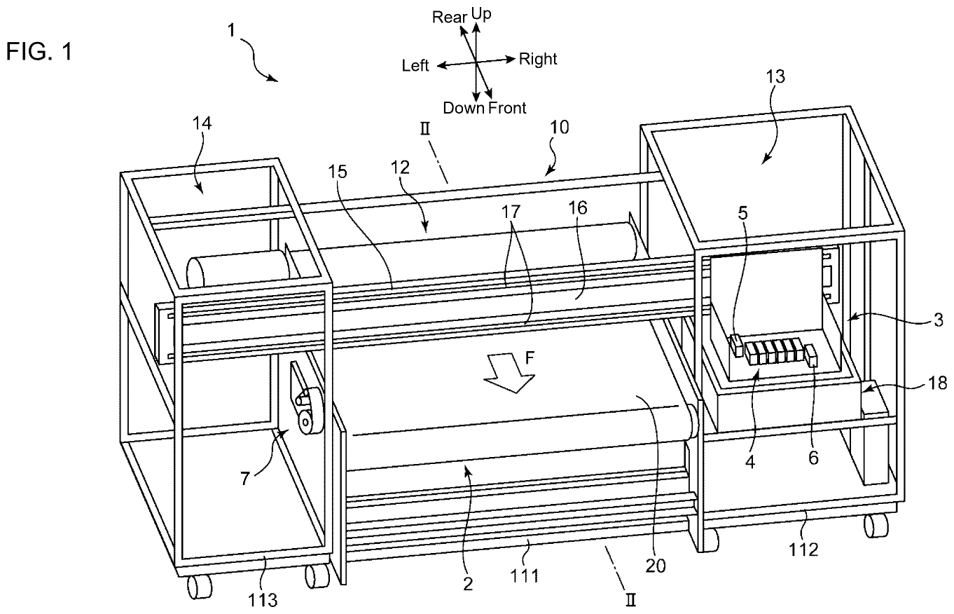

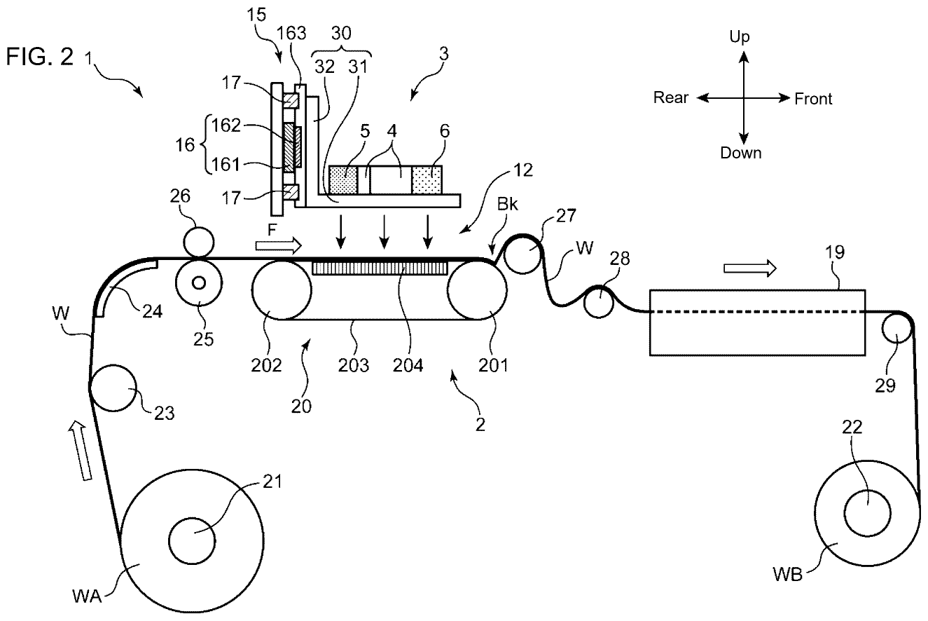

An inkjet printer 1 will be first described as an example of an apparatus including the cleaning device or using the cleaning method for a nozzle placement surface according to one or more embodiments of the present disclosure. FIG. 1 is perspective view of the inkjet printer 1 in one or more embodiments, illustrating the overall structure. FIG. 2 is a schematic cross-sectional view taken along line II-II in FIG. 1. The inkjet printer 1 prints images on a wide and elongated workpiece W by inkjet printing. The inkjet printer 1 includes an apparatus frame 10, a workpiece feeder 2 and a carriage 3 incorporated in the apparatus frame 10, and a dryer 19 located in front of the apparatus frame 10. Note that the dryer 19 is not illustrated in FIG. 1. In the present embodiment, a lateral direction is a main scanning direction in printing on the workpiece W, and a direction from rear to front is a subscanning direction, which is a transport direction F of the workpiece W.

The apparatus frame 10 is a frame on which various components of the inkjet printer 1 are mounted. The workpiece feeder 2 feeds the workpiece W intermittently to allow the workpiece W to travel in the transport direction F from rear to front in a printing area in which an inkjet printing process is performed. The carriage 3 receives ink heads 4, a pretreatment head 5, a post-treatment head 6, and subtanks (not illustrated). The carriage 3 reciprocates in the lateral direction in the inkjet printing process.

The apparatus frame 10 includes a center frame 111, a right frame 112, and a left frame 113. The center frame 111 is a frame on which various components of the inkjet printer 1 are mounted. The center frame 111 has a lateral width corresponding to the workpiece feeder 2. The right frame 112 stands on the right of the center frame 111, and the left frame 113 stands on the left of the center frame 111. A printing area 12 in which the printing process is performed on the workpiece W is defined between the right frame 112 and the left frame 113.

The right frame 112 defines a blade wipe area 13. The blade wipe area 13 is also an area into which the carriage 3 is retracted when the printing process is not performed. In this area, the heads are purged and the nozzle placement surface of the carriage 3 is cleaned with a blade for maintenance. In the blade wipe area 13, a blade wipe device 18 for the purging and the blade cleaning is located. The purging is a process of forcibly ejecting ink or treatment liquids from nozzles of the ink heads 4, the pretreatment head 5, and the post-treatment head 6. The blade cleaning uses a cleaning blade to wipe the lower surfaces of the heads 4, 5, and 6, or more specifically, the nozzle placement surface. The blade wipe device 18 also serves as a cap to reduce drying of the heads 4, 5, and 6 not in operation.

The left frame 113 defines a fabric wipe area 14. The fabric wipe area 14 is an area in which fabric-wipe cleaning is performed to clean the nozzle placement surface with a fabric sheet. In the fabric wipe area 14, a fabric wipe device 7 for the fabric-wipe cleaning is located. The fabric wipe device 7 will be described in detail later. Note that the fabric wipe area 14 is also an area in which the carriage 3 turns backward. The carriage 3 that has scanned the printing area 12 from right to left in the printing process temporarily enters the fabric wipe area 14 before performing scanning in a reverse direction.

The apparatus frame 10 receives, on its upper portion, a single-axis robot 15 for causing the carriage 3 to reciprocate in the lateral direction, or more specifically, in the main scanning direction in the printing process. The single-axis robot 15 extends in the lateral direction above the workpiece feeder 2. The single-axis robot 15 includes a linear motor 16 and a pair of upper and lower guide rails 17. The linear motor 16 includes a stator 161 located in a direction in which the single-axis robot 15 extends and a rotor 162 movable along the guide rails 17. The pair of guide rails 17 extend parallel to each other in the lateral direction. The pair of guide rails 17 are engaged with a movable block 163 on which the rotor 162 is mounted. The carriage 3 is mounted on the movable block 163 and moved by the single-axis robot 15 to the left or right.

Referring mainly to FIG. 2, the workpiece feeder 2 includes a feed roller 21 that unwinds the unprinted workpiece W in the transport direction F, a winding roller 22 that winds the printed workpiece W, and a transport unit 20 located in the printing area 12. The feed roller 21 is a winding shaft of a feed roll WA as a wound roll of the unprinted workpiece W. The winding roller 22 is a winding shaft of a winding roll WB as a wound roll of the printed workpiece W. The feed roller 21 is located upstream from the printing area 12, and the winding roller 22 is located downstream from the dryer 19.

The workpiece W is fed along a feed path extending through the printing area 12 between the feed roller 21 and the winding roller 22. The feed path includes, in the order from upstream, a tension roller 23, a workpiece guide 24, a transport roller 25, a pinch roller 26, the transport unit 20, a releasing roller 27, a loading roller 28, the dryer 19, and a turn roller 29.

The tension roller 23 applies a predetermined tension to the workpiece W upstream from the transport roller 25. The workpiece guide 24 changes the transport direction F of the workpiece W from upward to frontward and feeds the workpiece W into the printing area 12. The transport roller 25 generates a feed force for feeding the workpiece W intermittently in the printing area 12. The pinch roller 26 forms a feed nip with the transport roller 25. The transport roller 25 and the pinch roller 26 as a pair unwind the workpiece W from the feed roll WA, intermittently feeding the workpiece W in the transport direction F to pass through the printing area 12.

The transport unit 20 is located to stably feed the workpiece W through the printing area 12 without a rise or wobbles. The transport unit 20 includes a drive roller 201 and a follower roller 202 spaced from each other in a front-rear direction, and a conveyor belt 203 extending over the rollers 201 and 202. The workpiece W is fed in the transport direction F while being in close contact with a front surface of the conveyor belt 203. A platen 204 is located between the rollers 201 and 202 on a back surface of the conveyor belt 203. In the printing area 12, ink and treatment liquids are ejected from the ink heads 4, the pretreatment head 5, and the post-treatment head 6 to the workpiece W.

The releasing roller 27 is located obliquely in front of the drive roller 201 to release the printed workpiece W in close contact with the front surface of the conveyor belt 203 from the front surface. The workpiece W is released from the conveyor belt 203 at a releasing point Bk, at which the workpiece W is bent at a predetermined release angle. The workpiece W is then fed to the loading roller 28 downstream. The workpiece W is slack between the releasing roller 27 and the loading roller 28. The printed workpiece W is fed from the loading roller 28 to the dryer 19. The dryer 19 blows, for example, warm air to the wet workpiece W for drying. The turn roller 29 changes the transport direction F of the dried workpiece W from frontward to downward to guide the workpiece W to the winding roller 22.

The carriage 3 reciprocates, while being supported by the movable block 163 in a cantilevered manner, in the main scanning direction (lateral direction) intersecting with the transport direction F. The carriage 3 includes a carriage frame 30 on which the ink heads 4, the pretreatment head 5, the post-treatment head 6, and the subtanks (not illustrated) are mounted. The carriage frame 30 includes a head support frame 31 and a back frame 32. The head support frame 31 is a horizontal plate holding the heads 4 to 6 described above. The back frame 32 is a vertical plate extending upward from a rear edge of the head support frame 31. The back frame 32 is fixed to the movable block 163.

### Details of Carriage

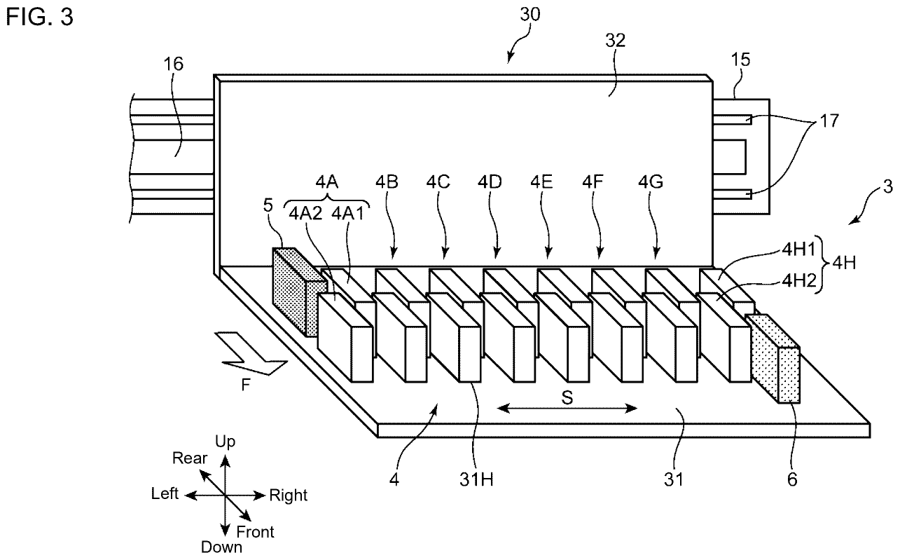

The carriage 3 will be described further. FIG. 3 is an enlarged perspective view of the carriage 3 illustrated in FIG. 1. FIG. 3 illustrates the transport direction F (subscanning direction) of the workpiece W and a main scanning direction S in which the carriage 3 moves. In the example illustrated in FIG. 3, the carriage 3 carries multiple ink heads 4 that eject ink for image formation onto the workpiece W, and the pretreatment head 5 and the post-treatment head 6 that eject noncolor-developing treatment liquids. The actual carriage 3 also includes multiple subtanks for supplying the ink and the treatment liquids to the heads 4, 5, and 6. Note that the ink heads 4 briefly illustrated in FIG. 1 are illustrated more specifically in FIG. 3.

Each of the ink heads 4 includes many nozzles and an ink channel that guides ink to the nozzles. The nozzles eject ink droplets by, for example, piezoelectric ejection using piezoelectric elements or thermal ejection using heating elements. The same or a similar structure applies to the pretreatment head 5 and the post-treatment head 6. Examples of the ink include water-based pigment ink containing a water-based solvent, a pigment, and a bonding resin. The multiple ink heads 4 in the present embodiment include first to eighth ink heads 4A to 4H that eject eight different colors of ink.

The ink heads 4A to 4H for different colors are arranged on the head support frame 31 in the carriage 3 in the main scanning direction S. Each of the ink heads 4A to 4H for different colors includes two heads. For example, the first ink heads 4A include an upstream head 4A1 located upstream in the transport direction F and a downstream head 4A2 located downstream from the upstream head 4A1 and shifted leftward in the main scanning direction S. The same or a similar structure applies to the other ink heads 4B to 4H. The upstream heads in the ink heads 4B to 4H are aligned with the upstream head 4A1 in the main scanning direction S at the same position in the transport direction F. The downstream heads in the ink heads 4B to 4H are aligned with the downstream head 4A2 in the main scanning direction S at the same position in the transport direction F.

The pretreatment head 5 and the post-treatment head 6 are at positions different from the positions of the ink heads 4 in the transport direction F. The pretreatment head 5 is located upstream from the ink heads 4 in the transport direction F. In the example illustrated in FIG. 3, one pretreatment head 5 is located near the left end of an array of the ink heads 4. The pretreatment head 5 is on the left of the upstream head 4A1 in the first ink heads 4A, behind the downstream head 4A2, and at the same position as the downstream head 4A2 in the main scanning direction S. In contrast, the post-treatment head 6 is located downstream from the ink heads 4 in the transport direction F. In the example illustrated in FIG. 3, one post-treatment head 6 is located near the right end of the array of the ink heads 4. The post-treatment head 6 is on the right of the downstream head 4H2 in the eighth ink heads 4H, in front of the upstream head 4H1, and at the same position as the upstream head 4H1 in the main scanning direction S.

The pretreatment head 5 ejects a pretreatment liquid for a predetermined pretreatment of the workpiece W. The pretreatment liquid is ejected from the pretreatment head 5 to an area of the workpiece W on which no ink has been ejected from the ink heads 4. The pretreatment liquid is a noncolor-developing treatment liquid that develops no color on the workpiece W. The pretreatment liquid improves, for example, fixation of ink on the workpiece W or facilitates agglomeration of ink pigments. Examples of the pretreatment liquid may include a treatment liquid of a solvent containing a bonding resin or a treatment liquid of a solvent containing a positively charged cationic resin.

The post-treatment head 6 ejects a post-treatment liquid for a predetermined post-treatment of the workpiece W on which ink is applied. The post-treatment liquid is ejected from the post-treatment head 6 to an area of the workpiece W on which ink has been ejected from the ink heads 4. The post-treatment liquid is also a noncolor-developing treatment liquid that develops no color on the workpiece W. The post-treatment liquid improves the fixation and the toughness, such as durability against rubbing or scratching, of an ink image printed on the workpiece W by the ink heads 4. Examples of the post-treatment liquid include a silicone treatment liquid.

The head support frame 31 includes openings 31H at positions of the heads. The head support frame 31 receives the ink heads 4A to 4F, the pretreatment head 5, and the post-treatment head 6 fitted into the respective openings 31H. The nozzles on lower end faces of the heads 4, 5, and 6 are exposed on the corresponding openings 31H.

As described above, the inkjet printer 1 in the present embodiment is an all-in-one printer including three types of heads, or the ink heads 4, the pretreatment head 5, and the post-treatment head 6, mounted on the single carriage 3. The printer 1 can integrally perform the pretreatment liquid ejection and the post-treatment liquid ejection in an inkjet printing process on a textile in, for example, digital textile printing. This can simplify the textile printing process and reduce the size of textile printing apparatuses.

### Head Maintenance

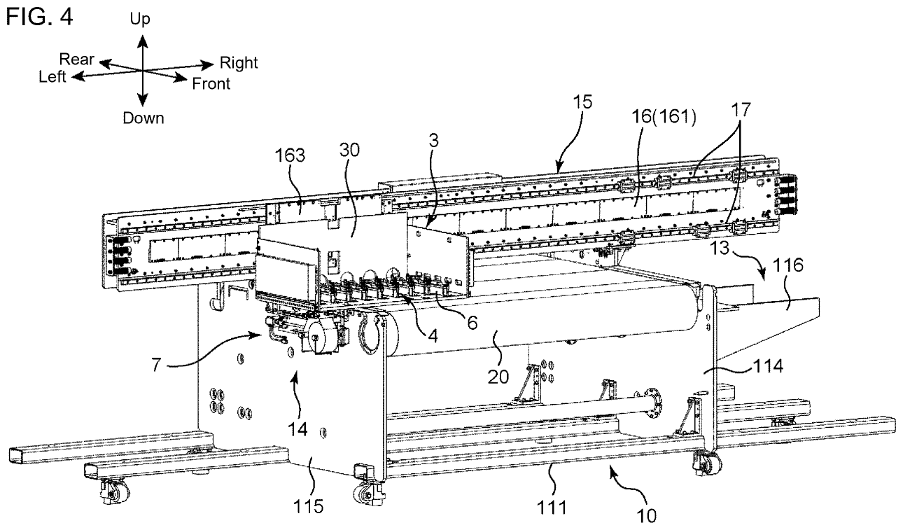

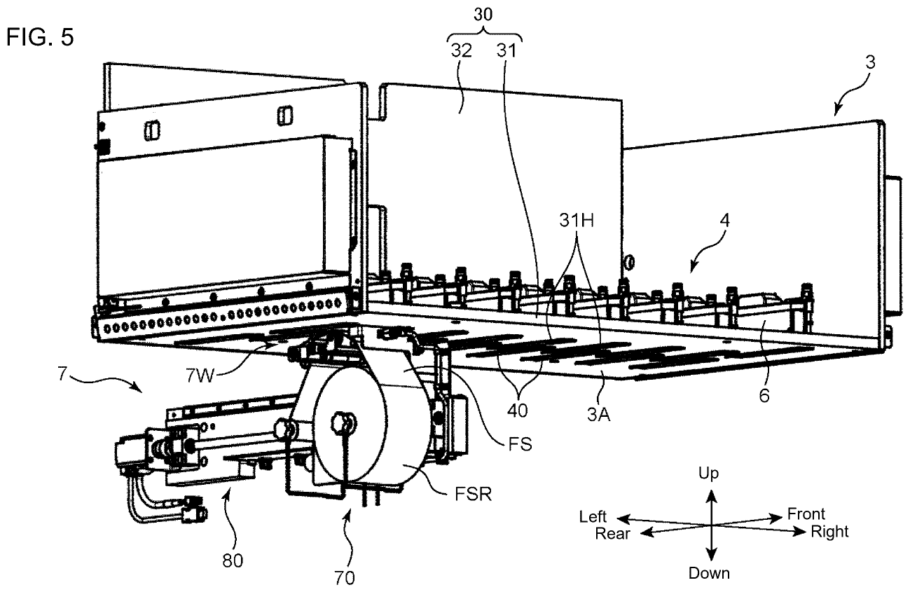

As described above, the inkjet printer 1 includes the blade wipe device 18 and the fabric wipe device 7 for maintenance of the heads 4, 5, and 6. The blade wipe device 18 cleans the nozzle placement surface using a cleaning blade. The fabric wipe device 7 cleans the nozzle placement surface using a fabric sheet. FIG. 4 is a perspective view of part of the apparatus frame 10 and the single-axis robot 15, with the carriage 3 moved to the fabric wipe area 14. FIG. 5 is a perspective view of a nozzle placement surface 3A of the carriage 3, cleaned with the fabric wipe device 7.

The apparatus frame 10 includes a right plate 114 and a left plate 115 located on the right and left of the center frame 111. The blade wipe area 13 is on the right of the right plate 114. The fabric wipe area 14 is on the left of the left plate 115. A blade wipe holder 116 is attached to the right plate 114. The blade wipe holder 116 is a frame holding the blade wipe device 18 (FIG. 1). The fabric wipe device 7 is attached to the left plate 115.

Referring to FIG. 5, the head support frame 31 in the carriage frame 30 includes, as described above, the openings 31H each with a size corresponding to one head. The ink heads 4, the pretreatment head 5, and the post-treatment head 6 are fitted into the openings 31H. The heads 4, 5, and 6 include nozzle surfaces 40 exposed on the nozzle placement surface 3A, which is a back surface of the head support frame 31. The nozzle surfaces 40 each include nozzle holes arranged in a predetermined pattern.

The blade wipe device 18 cleans the nozzle placement surface 3A with a blade regularly based on, for example, the print time, the printing area size, and the operating days. During the cleaning with the blade, the single-axis robot 15 moves the carriage 3 to the blade wipe area 13. Before the blade cleaning, the ink heads 4, the pretreatment head 5, and the post-treatment head 6 are purged to forcibly eject ink or the treatment liquids. After purging, the blade wipe device 18 performs a contactless wipe to wipe droplets dripping from the nozzle surfaces 40 with the cleaning blade and a contact wipe to wipe the nozzle surfaces 40 with the cleaning blade in contact with the nozzle surfaces 40.

After the blade cleaning described above, the fabric wipe device 7 performs the fabric-wipe cleaning on the ink heads 4 alone. The fabric-wipe cleaning is performed on the ink heads 4 alone because the ink heads 4 eject liquids (ink) containing pigment. Such liquids remaining on the nozzle surfaces 40 may not be cleaned sufficiently with the blade cleaning. The pretreatment head 5 and the post-treatment head 6, which eject liquids free of pigment, do not usually involve the fabric-wipe cleaning. Note that the fabric-wipe cleaning is performed without the purging described above. For the fabric-wipe cleaning, the carriage 3 is moved to the fabric wipe area 14 as illustrated in FIG. 4.

The fabric wipe device 7 includes a fabric wiper 70 and a mover 80. The fabric wiper 70 includes a fabric sheet roll FSR, which is a bundle of fabric sheet for fabric wipe. The mover 80 moves the fabric wiper 70 in the front-rear direction. In the fabric-wipe cleaning, the nozzle surfaces 40 exposed on the nozzle placement surface 3A are pressed against a wipe portion 7W defined by a fabric sheet FS unwound from the fabric sheet roll FSR. FIG. 5 illustrates this pressed state. The mover 80 moves the fabric wiper 70 rearward in this pressed state to wipe and clean the nozzle surfaces 40 with the fabric sheet FS defining the wipe portion 7W.

### Details of Fabric Wipe Device

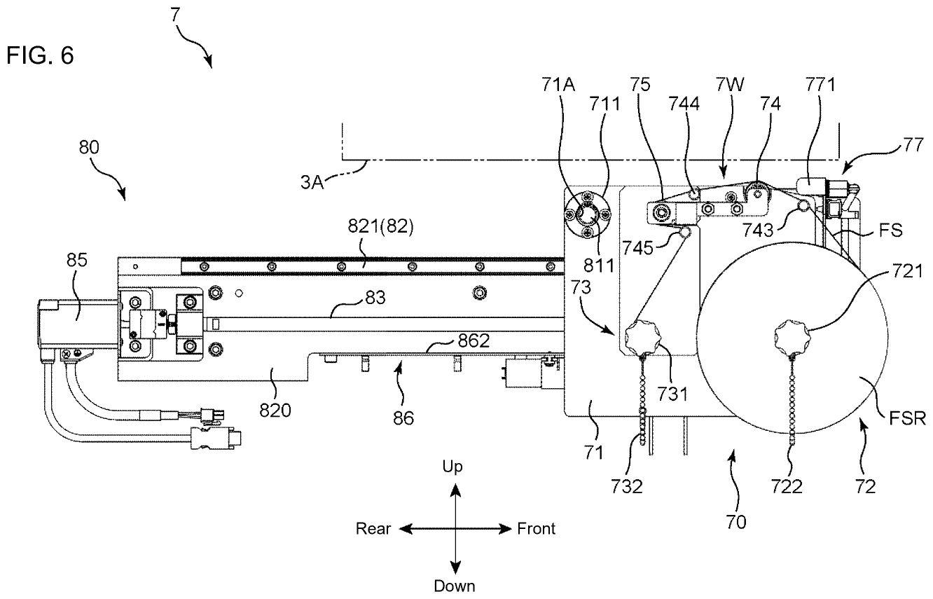

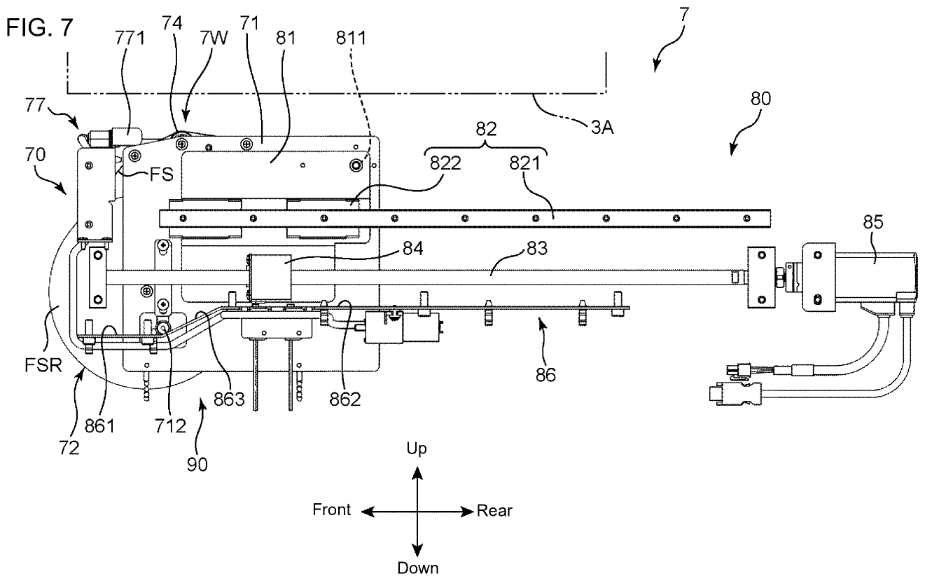

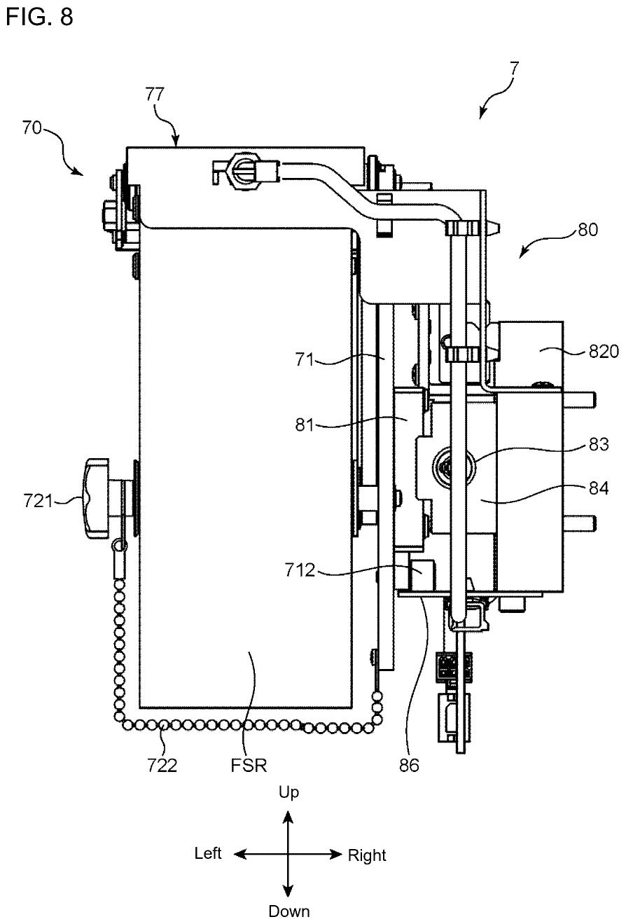

The structure and the operation of the fabric wipe device 7 will now be described in detail. FIG. 6 is a left side view of the fabric wipe device 7. FIG. 7 is a right side view of the fabric wipe device 7. FIG. 8 is a front view of the fabric wipe device 7. The fabric wipe device 7 includes the fabric wiper 70, the mover 80, and an orientation switcher 90.

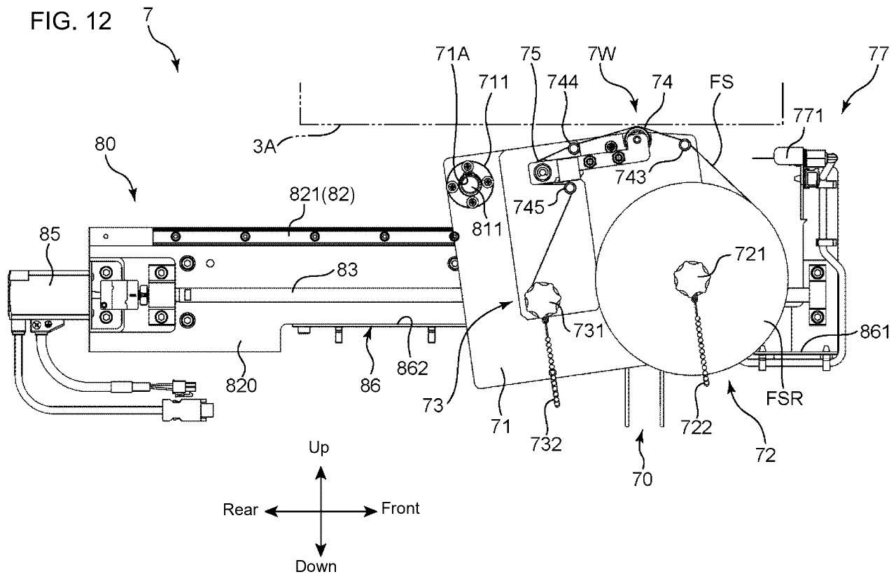

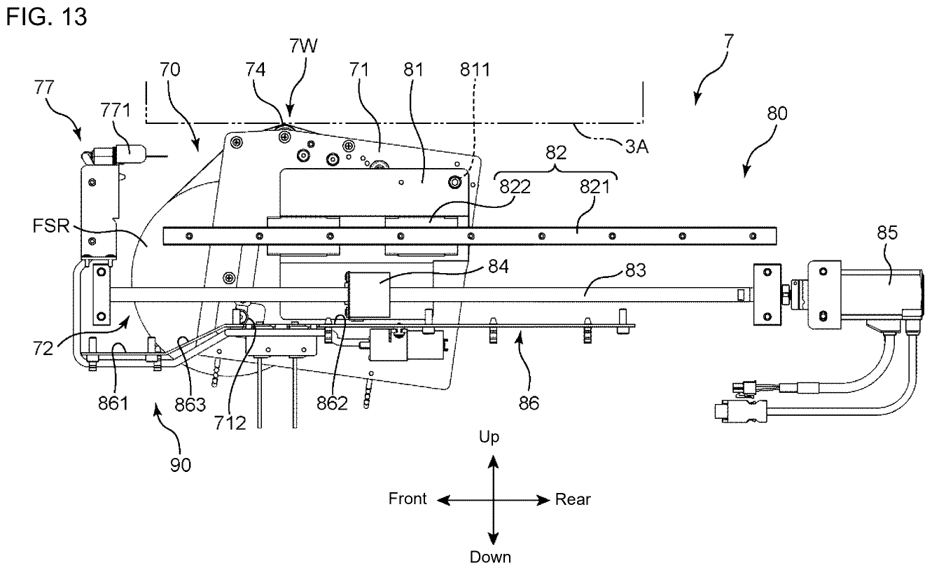

The fabric wiper 70 includes the wipe portion 7W defined by a portion of the fabric sheet FS as described above to physically perform the fabric-wipe cleaning. The mover 80 can move the fabric wiper 70 between a cleaning position at which the fabric wiper 70 cleans the nozzle placement surface 3A and a retracted position at which the fabric wiper 70 does not perform the cleaning. The fabric wiper 70 illustrated in FIGS. 6 and 7 is at the retracted position. The fabric wiper 70 illustrated in FIGS. 12 and 13 (described later) is at the cleaning position. The orientation switcher 90 can switch the orientation of the wipe portion 7W. The orientation switcher 90 causes the wipe portion 7W to be in a cleaning orientation at the cleaning position and in a retracted orientation at the retracted position. In the cleaning orientation, the wipe portion 7W is in contact with the nozzle placement surface 3A. In the retracted position, the wipe portion 7W is separated downward from the nozzle placement surface 3A. In the retracted orientation, the wipe portion 7W is separate from the nozzle placement surface 3A.

### Mover

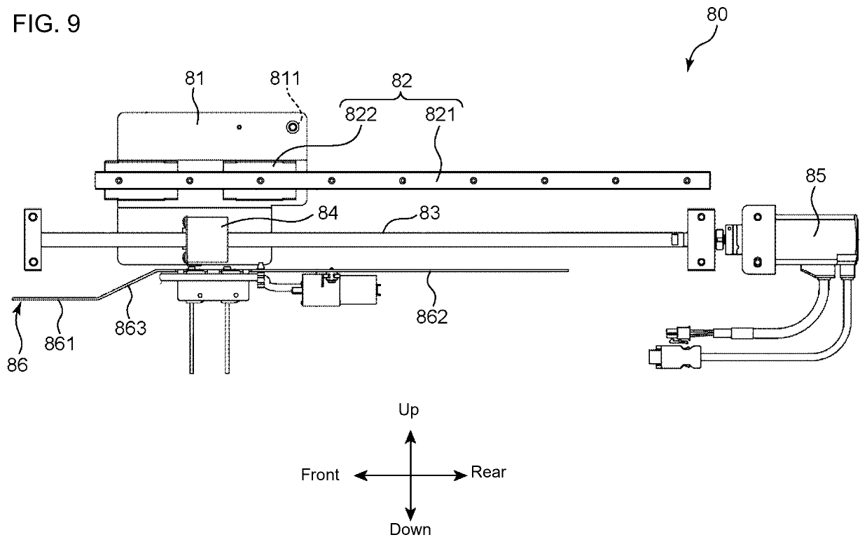

The structure of the mover 80 will now be described with reference to FIG. 9 illustrating a side view of the mover 80, as well as to FIGS. 6 to 8. The mover 80 includes a movable member 81, a linear guide 82, a ball screw 83, a nut 84, a fabric wiper motor 85, and an orientation switch guide 86.

The movable member 81 is a substantially rectangular flat plate as viewed laterally. The movable member 81 is movable in the front-rear direction along the linear guide 82. The fabric wiper 70 is mounted on the movable member 81. A pivot pin 811 protruding leftward is attached to the movable member 81 near the upper rear corner of the movable member 81. The pivot pin 811 is an engagement pin used to mount the fabric wiper 70. The pivot pin 811 also serves as a pivot of the fabric wiper 70. More specifically, the fabric wiper 70 is mounted on the movable member 81 in a manner pivotable about the pivot pin 811.

The linear guide 82 includes a guide base 820, a guide rail 821, and a block 822. The guide base 820 is a flat plate elongated in the front-rear direction. The guide base 820 is a base to which the guide rail 821, the ball screw 83, the fabric wiper motor 85, and the orientation switch guide 86 are attached. The guide base 820 is fixed to the left plate 115 (FIG. 4) in the apparatus frame 10. Note that the guide base 820 is not illustrated in FIGS. 7 and 9. The guide rail 821 has any polygonal cross section. The guide rail 821 extends linearly in the front-rear direction. The block 822 is fitted on the guide rail 821 to move along the guide rail 821 in the front-rear direction. The movable member 81 is fixed to the block 822.

Note that the linear guide 82 may be replaced with a linear shaft, which includes a shaft having a circular cross section and a cylindrical movable block placed through the shaft.

The ball screw 83 is axially supported by the guide base 820 to extend in the front-rear direction along the guide rail 821. The nut 84 is screwed on the ball screw 83 and attached to the movable member 81. The fabric wiper motor 85 includes a motor shaft connected to a rear end of the ball screw 83 to rotate the ball screw 83 forward or reversely about the shaft. When the fabric wiper motor 85 rotates the ball screw 83, the nut 84 moves in the front-rear direction, causing the movable member 81 to move in the front-rear direction while being guided by the guide rail 821.

The orientation switch guide 86 comes in contact with a contact portion of the fabric wiper 70 when the movable member 81 moves. The pivot orientation of the fabric wiper 70 about the pivot pin 811 is switched based on the position at which the contact portion comes in contact with the orientation switch guide 86. This will be described later. The orientation switch guide 86 includes a first portion 861, a second portion 862, and a slope 863. The first portion 861 extends horizontally in the front-rear direction at a predetermined height (first height). The front-rear direction is a direction in which the linear guide 82 extends. The second portion 862 is at a height (a second height) higher than the first portion 861 by a predetermined length. The second portion 862 extends horizontally in the front-rear direction at a position spaced and rearward from the first portion 861. The slope 863 connects the first portion 861 and the second portion 862 having a height difference.

### Fabric Wiper

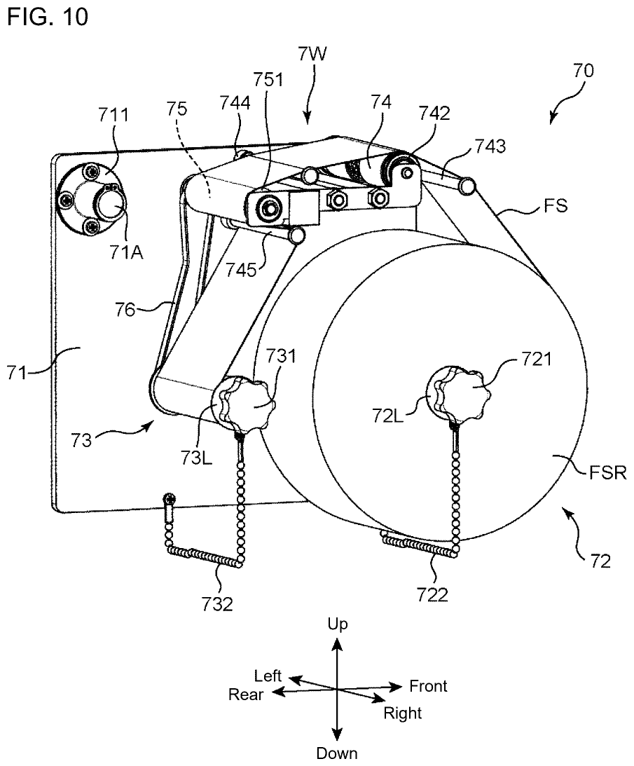

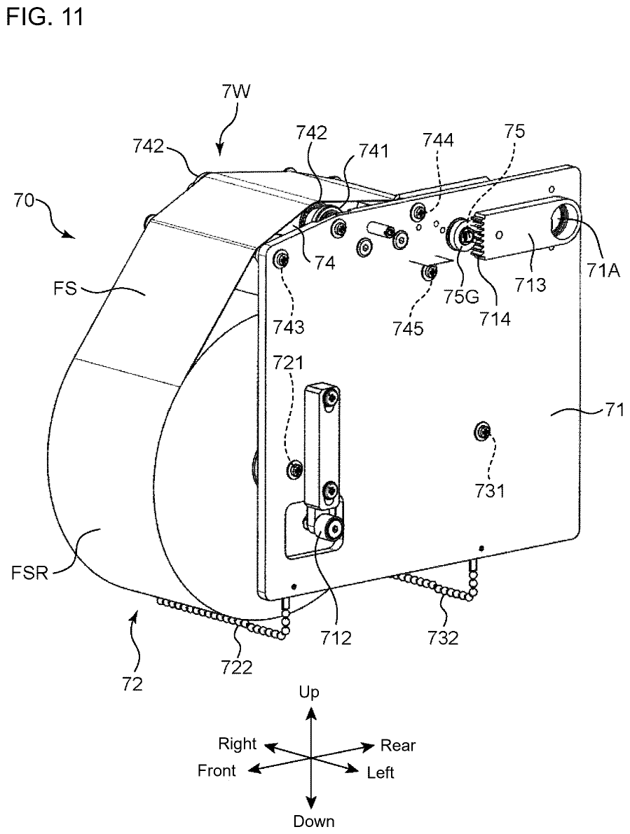

The structure of the fabric wiper 70 will now be described with reference to FIGS. 10 and 11, which are perspective views of the fabric wiper 70, as well as to FIGS. 6 to 8. The fabric wiper 70 includes a base 71, a feeder portion 72, a takeup portion 73, a press roller 74, a transport roller 75, and a transmission belt 76.

The base 71 is a substantially square flat plate larger than the movable member 81 as viewed laterally. The components of the fabric wiper 70 are mounted on the base 71. A bearing bush 711 (pivot) protrudes from the right surface of the base 71 near the upper rear corner of the base 71. The bearing bush 711 includes a rotation shaft hole 71A through which the pivot pin 811 in the movable member 81 is placed. The base 71 is pivotable relative to the movable member 81 about the bearing bush 711 serving as a pivot axially supported by the pivot pin 811.

The base 71 includes, near the front lower corner of its left surface, a roller 712 (contact portion) rotatable about an axis extending in the lateral direction. The corner at which the roller 712 is located is diagonal to the corner at which the bearing bush 711 is located. The roller 712 comes in contact with the orientation switch guide 86 and rolls when the movable member 81 moves. As illustrated in FIG. 7, with the roller 712 in contact with the first portion 861 in the orientation switch guide 86, the base 71 is in a horizontal orientation. As described later with reference to FIG. 13, with the roller 712 in contact with the second portion 862 located higher than the first portion 861, the base 71 pivots about the pivot pin 811 to have its front portion lifted.

The feeder portion 72 and the takeup portion 73 are joined to the base 71. The feeder portion 72 unwinds the fabric sheet FS for fabric-wipe cleaning. The feeder portion 72 includes an unwinding roller 721 that holds the fabric sheet roll FSR being a wound body of an unused portion of the fabric sheet FS. The unwinding roller 721 receives a torque limiter 72L on its rotational shaft. A roll receiver 722 extends between the base 71 and the shaft end of the unwinding roller 721.

The takeup portion 73 rewinds the fabric sheet FS used in fabric-wipe cleaning. The takeup portion 73 includes a winding roller 731 around which a used portion of the fabric sheet FS is wound. The winding roller 731 also receives a torque limiter 73L on its rotational shaft. A roll receiver 732 extends between the base 71 and the shaft end of the winding roller 731.

The wipe portion 7W defined by the fabric sheet FS extends between the feeder portion 72 and the takeup portion 73. The wipe portion 7W is a portion of the elongated fabric sheet FS wound as the fabric sheet roll FSR. The wipe portion 7W is pressed against the nozzle placement surface 3A of the carriage 3 to physically wipe the nozzle surfaces 40 in fabric-wipe cleaning. The wipe portion 7W is sequentially fed with an unused portion of fabric sheet FS from the fabric sheet roll FSR in the feeder portion 72. The fabric sheet FS in the wipe portion 7W used in the fabric-wipe cleaning is sequentially rewound by the takeup portion 73.

The press roller 74 is an elastic roller. The press roller 74 supports the fabric sheet FS in the wipe portion 7W. The press roller 74 presses the fabric sheet FS in the wipe portion 7W against the nozzle placement surface 3A. The press roller 74 is axially supported near the upper side of the base 71 to partially protrude upward from the upper side of the base 71. The press roller 74 supports the fabric sheet FS from below to cause the fabric sheet FS in the wipe portion 7W to also protrude upward from the upper side of the base 71.

The press roller 74 receives a one-way clutch 741 on its rotational shaft. The press roller 74 is a follower roller without a drive source. The one-way clutch 741 is located to rotate the follower press roller 74 only in the unwinding direction of the fabric sheet FS. The one-way clutch 741 prevents the fabric sheet FS once unwound from the fabric sheet rolls FSR from returning to the feeder portion 72.

The press roller 74 receives pulleys 742 on both ends of the rotational shaft. Whereas the press roller 74 is elastically deformable, the pulleys 742 are made of a hard material that is substantially elastically nondeformable. When the press roller 74 and the pair of pulleys 742 coaxial with each other are pressed against the nozzle placement surface 3A, the pulleys 742 determine the positional relationship between the rotational shaft and the nozzle placement surface 3A. This maintains a constant distance between the circumferential surface of the press roller 74 and the nozzle placement surface 3A. The extent by which the fabric sheet FS is pressed onto the nozzle placement surface 3A by the press roller 74 can thus be constant and axially uniform.

In the unwinding direction of the fabric sheet FS, a first guide roller 743 is located upstream from the press roller 74, and a second guide roller 744 is located downstream from the press roller 74. The transport roller 75 is located downstream from the second guide roller 744, and a tension roller 745 is located downstream from the transport roller 75.

The first and second guide rollers 743 and 744 are also axially supported near the upper side of the base 71. The rollers 743 and 744 and the press roller 74 have a relatively small level difference on their circumferential surfaces. The first and second guide rollers 743 and 744 allow the fabric sheet FS to be wound on the press roller 74 at a larger angle, thus easily increasing the area of the fabric sheet FS in the wipe portion 7W in contact with the nozzle placement surface 3A. The feeding direction of the fabric sheet FS is reversed by the transport roller 75 and then redirected by the tension roller 745. The tension roller 745 applies tension to the fabric sheet FS being fed toward the takeup portion 73. In the retracted orientation, the first guide roller 743 is located below the second guide roller 744. In the cleaning orientation, the first guide roller 743 is located above the second guide roller 744.

The transport roller 75 feeds the fabric sheet FS from the feeder portion 72 toward the takeup portion 73 through the wipe portion 7W. More specifically, the transport roller 75 rotating about the axis feeds the fabric sheet FS wound on the transport roller 75 downstream. The transport roller 75 includes no drive source such as a motor. The transport roller 75 is axially supported by the base 71 in a rotatable manner. The transport roller 75 receives a one-way clutch 751 on its rotational shaft. The one-way clutch 751 rotates the transport roller 75 in the feeding direction of the fabric sheet FS to the takeup portion 73 alone.

As illustrated in FIG. 11, the rotational shaft of the transport roller 75 protrudes from the left surface of the base 71. The protrusion receives a roller gear 75G (first gear) on its rotational shaft. Rotation of the roller gear 75G rotates the transport roller 75. The roller gear 75G meshes with a rack gear 713 (second gear). The rack gear 713 is fixed to the movable member 81 in the mover 80. The rack gear 713 includes a sector gear 714 meshing with the roller gear 75G.

The roller gear 75G and the rack gear 713 together operate as a link assembly that causes the transport roller 75 to rotate about an axis in response to the fabric wiper 70 pivoting about the pivot pin 811 to switch the orientation. More specifically, when the base 71 pivots relative to the movable member 81 about the bearing bush 711 serving as a pivot, the roller gear 75G meshing with the sector gear 714 in the fixed state rotates. As the roller gear 75G rotates, the transport roller 75 rotates. The fabric sheet FS is fed downstream by the degree of the rotation. This feeding operation unwinds the sheet FS from the feeder portion 72. This directs a fresh portion of the fabric sheet FS to the wipe portion 7W.

The rotation of the transport roller 75 also causes a used portion of the sheet FS to be rewound by the takeup portion 73. As illustrated in FIG. 10, the transmission belt 76 extends between the transport roller 75 and the winding roller 731. The transmission belt 76 causes the rotational shaft of the winding roller 731 to rotate in response to rotation of the rotational shaft of the transport roller 75. When the transport roller 75 rotates by a predetermined degree in response to switching of the orientation of the fabric wiper 70, the rotation is transmitted to the winding roller 731 by the transmission belt 76. More specifically, the winding roller 731 winds the fabric sheet FS by the degree by which the transport roller 75 rotates. The torque limiter 73L is incorporated in the rotational shaft of the winding roller 731. The torque limiter 73L reduces excess pulling of the fabric sheet FS when the roll of the fabric sheet FS rewound by the winding roller 731 has a larger diameter to increase the amount of sheet rewound per unit rotation.

A spray unit 77 is located between the first guide roller 743 and the press roller 74. The spray unit 77 includes a spray gun 771 that blows a cleaning liquid that is a liquid containing pure water or a cleaning component. The spray unit 77 is attached to the left plate 115 (FIG. 4) in the apparatus frame 10. The spray gun 771 sprays the cleaning liquid onto the fabric sheet FS in the wipe portion 7W upstream from the press roller 74. The fabric sheet FS wetted with the cleaning liquid immediately before fabric-wipe cleaning can increase the efficiency of cleaning the nozzle surfaces 40.

### Operation of Fabric Wipe Device

The operation of the fabric wipe device 7 with the above structure will now be described with reference to the comparison between FIGS. 6 and 12 and the comparison between FIGS. 7 and 13. The mover 80 moves the fabric wiper 70 mounted on the movable member 81 between the retracted position (FIGS. 6 and 7) and the cleaning position (FIGS. 12 and 13). At the retracted position, the fabric wiper 70 does not clean the nozzle placement surface 3A. At the cleaning position, the fabric wiper 70 can clean the nozzle placement surface 3A. In the present embodiment, the retracted position corresponds to a section in which the roller 712 in the fabric wiper 70 is in contact with the first portion 861 in the orientation switch guide 86. The cleaning position corresponds to a section in which the roller 712 is in contact with the second portion 862.

The orientation switcher 90 switches the fabric wiper 70 between the retracted orientation (FIGS. 6 and 7) and the cleaning orientation (FIGS. 12 and 13). In the retracted orientation, the wipe portion 7W is separate from the nozzle placement surface 3A. In the cleaning orientation, the wipe portion 7W is in contact with the nozzle placement surface 3A. In the present embodiment, the retracted position matches the retracted orientation, and the cleaning position matches the cleaning orientation. More specifically, the fabric wiper 70 moved to the retracted position is in the retracted orientation. The fabric wiper 70 moved to the cleaning position pivots relative to the movable member 81 to be in the cleaning orientation. In the present embodiment, the orientation switcher 90 includes the orientation switch guide 86 and a structure for causing the base 71 to pivot. The structure for the pivot includes the bearing bush 711, the roller 712, and the pivot pin 811.

The operation will be described further. As illustrated in FIGS. 6 and 7, when the fabric wiper 70 is at the retracted position and in the retracted orientation, the roller 712 in the base 71 is in contact with the first portion 861 in the orientation switch guide 86. In this state, the base 71 and the movable member 81 both being rectangular include their upper sides parallel to each other and the lower sides parallel to each other. More specifically, the base 71 and the movable member 81 are in a default state in which the base 71 does not pivot relative to the movable member 81. The wipe portion 7W is separated downward from the nozzle placement surface 3A. In other words, the position of the roller 712 and the height position of the first portion 861 are set to achieve the default state.

When the fabric wiper motor 85 is driven in the state illustrated in FIGS. 6 and 7 to move the movable member 81 rearward, the fabric wiper 70 also moves rearward. The roller 712 in contact with the first portion 861 in the orientation switch guide 86 comes in contact with the slope 863. As the roller 712 moves up on the slope 863, the base 71 pivots about the bearing bush 711 serving as a pivot and placed through the pivot pin 811, having the front end of the base 71 being lifted.

In FIGS. 12 and 13, the roller 712 has moved up to the second portion 862 through the slope 863. More specifically, the fabric wiper 70 is at the cleaning position and in the cleaning orientation. The roller 712 is lifted by the amount corresponding to the height difference between the first portion 861 and the second portion 862. The base 71 pivots about the pivot pin 811 by the rotation angle corresponding to the lifted amount. This pivot lifts the wipe portion 7W, causing the portion of the fabric sheet FS supported by the press roller 74 from below to come in contact with the nozzle placement surface 3A. More specifically, the nozzle placement surface 3A can be cleaned with the fabric sheet FS in the wipe portion 7W.

In this state, the pulleys 742 on both ends of the rotational shaft of the press roller 74 also come in contact with the nozzle placement surface 3A. The press roller 74 thus presses the fabric sheet FS by a predetermined restricted extent. This allows the fabric sheet FS in the wipe portion 7W to wipe the nozzle placement surface 3A uniformly and stably.

The pivoting base 71 rotates, by a predetermined angle, the roller gear 75G attached to the shaft end of the transport roller 75 and meshing with the sector gear 714 in the rack gear 713. The transport roller 75 thus rotates by a predetermined angle, feeding the fabric sheet FS by the length corresponding to the predetermined angle. More specifically, the fabric sheet FS is unwound from the fabric sheet roll FSR in the feeder portion 72 to feed a fresh portion of the fabric sheet FS to the wipe portion 7W. The unwinding roller 721 around which the fabric sheet roll FSR is wound includes the torque limiter 72L, which reduces slack of the fabric sheet FS between the feeder portion 72 and the press roller 74. Note that the spray unit 77 is activated at the time when the fresh portion of the fabric sheet FS is fed to the wipe portion 7W. The cleaning liquid is then spayed from the spray gun 771 onto the fabric sheet FS.

When the transport roller 75 rotates, the endless transmission belt 76 transmits a rotational force to rotate the winding roller 731. This causes the used portion of the fabric sheet FS to be wound around the winding roller 731 by a predetermined length. The winding roller 731 includes the torque limiter 73L. This structure reduces the likelihood of excess tension being applied to the fabric sheet FS between the transport roller 75 and the winding roller 731 when the roll of the fabric sheet FS rewound by the winding roller 731 has a larger diameter.

In the present embodiment as described above, the transport roller 75 is rotated in response to the base 71 pivoting. This eliminates use of any motor for driving the transport roller 75. The fabric sheet FS is unwound from the unwinding roller 721 and wound around the winding roller 731 in response to the base 71 pivoting. This structure uses no separate drive. The torque limiters 72L and 73L attached to both the unwinding roller 721 and the winding roller 731 allow appropriate winding and unwinding of the fabric sheet FS without controlling rotation of the rollers 721 and 731.

The movable member 81 in the state in FIGS. 12 and 13 is further moved rearward as being driven by the fabric wiper motor 85. This allows cleaning of the nozzle surfaces 40 on the nozzle placement surface 3A with the fabric sheet FS in the wipe portion 7W. In the present embodiment, as illustrated in FIG. 3, the ink heads 4 for different colors are aligned in two rows in the front-rear direction. The fabric sheet FS has a width that can cover two ink heads 4 arranged in the main scanning direction S. Thus, the wipe portion 7W may be moved by at least the distance corresponding to the stroke for the two front-rear rows. The second portion 862 in the orientation switch guide 86 thus has a length in the front-rear direction longer than the stroke.

After the wipe portion 7W is moved to the rear end to complete the fabric-wipe cleaning, the carriage 3 is lifted by a small amount to separate the wipe portion 7W from the nozzle placement surface 3A. The movable member 81 is then driven by the fabric wiper motor 85 to return to a front position. The position with which the roller 712 is in contact then changes from the second portion 862 to the slope 863 and to the first portion 861. This causes the base 71 to pivot about the pivot pin 811 to return to the horizontal state, or to the retracted position and the retracted orientation.

In this state, the sector gear 714 in the rack gear 713 meshes with the roller gear 75G. However, the one-way clutch 751 mounted on the transport roller 75 causes the roller gear 75G to simply rotate without meshing. The transport roller 75 thus does not rotate. The fabric sheet FS is not transported reversely toward the feeder portion 72. The carriage 3 is then moved in the main scanning direction S by a distance corresponding to two heads for fabric-wipe cleaning of the next set of ink heads 4. The fabric-wipe cleaning is repeated with the procedure described above.

### Control Structure

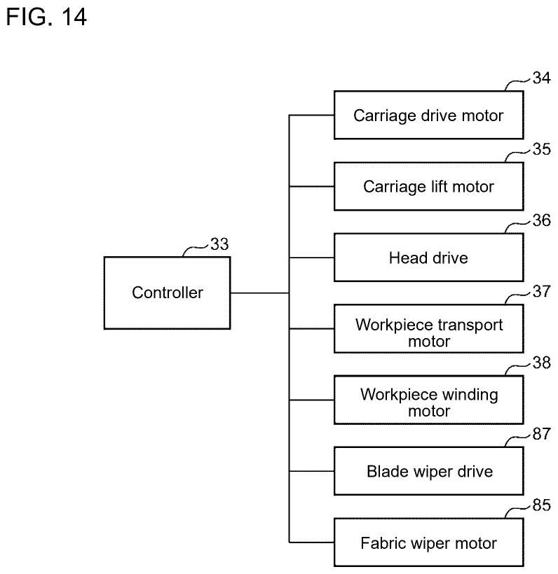

FIG. 14 is a block diagram of the printer 1 partially illustrating its control configuration. The printer 1 includes a controller 33, a carriage drive motor 34, a carriage lift motor 35, a head drive 36, a workpiece transport motor 37, a workpiece winding motor 38, a blade wiper drive 87, and the fabric wiper motor 85. The operations of these components other than the controller 33 are controlled by the controller 33.

The carriage drive motor 34 generates a driving force for laterally moving the carriage 3 between the blade wipe area 13 and the fabric wipe area 14 through the printing area 12. The carriage drive motor 34 corresponds to the linear motor 16 illustrated in FIG. 4. The carriage lift motor 35 generates a driving force for vertically moving the carriage 3 in the blade wipe area 13 and the fabric wipe area 14. The head drive 36 causes ejection of ink, a pretreatment liquid, and a post-treatment liquid from the heads 4, 5, and 6. The workpiece transport motor 37 is a driving source for transporting the workpiece W in the transport direction F in the printer 1. The workpiece transport motor 37 corresponds to, for example, the transport roller 25 or the drive roller 201 in the transport unit 20. The workpiece winding motor 38 is a driving source for rotating the winding roller 22 to wind the printed workpiece W.

The blade wiper drive 87 causes, under control performed by the controller 33, the blade wipe device 18 to operate to perform maintenance including purging and blade cleaning of the heads 4, 5, and 6. More specifically, the blade wiper drive 87 causes, as purging, the heads 4, 5, and 6 to respectively eject high-pressure ink, a pretreatment liquid, and a post-treatment liquid to clean the nozzles. In blade cleaning, the blade in the blade wiper included in the blade wipe device 18 is moved near the nozzle surfaces 40 of the heads 4, 5, and 6 for the contactless wipe described above and moved on the nozzle surfaces 40 for the contact wipe.

The fabric wiper motor 85 moves, under control performed by the controller 33 as a cleaning controller, the movable member 81 on which the fabric wiper 70 is mounted to perform the fabric-wipe cleaning of the ink heads 4. The controller 33 defines a cleaning sequence to clean the nozzle placement surface 3A with the fabric wiper 70 to control, for example, the fabric wiper motor 85 and the carriage drive motor 34 based on the cleaning sequence.

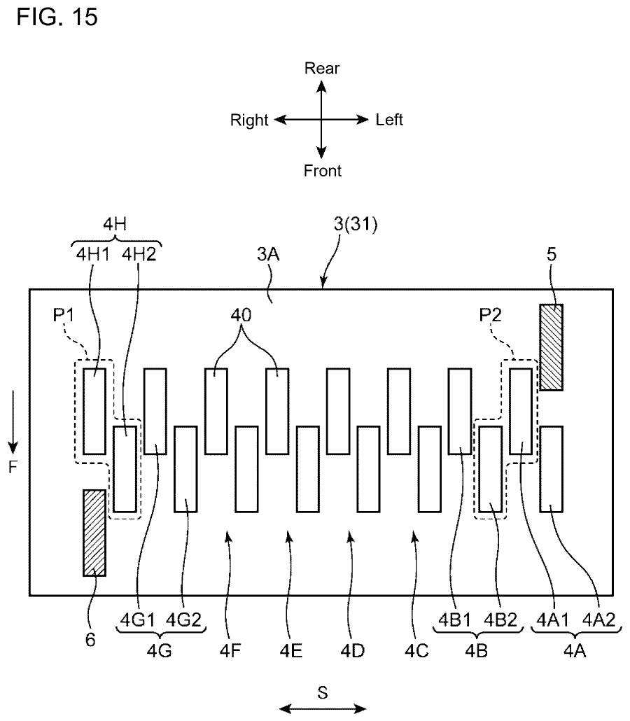

FIG. 15 is a plan view of the nozzle placement surface for describing a specific example of a cleaning sequence for a fabric wipe, illustrating the back surface of the carriage 3 in FIG. 3. In this example, the fabric sheet FS has a width that can cover two rows of the ink heads 4 in the main scanning direction S. The fabric-wipe cleaning is performed on the ink heads 4 alone. The fabric sheet FS used to wipe the ink heads 4 can cause aggregation of the ink or other failures when coming in contact with the pretreatment liquid or the post-treatment liquid. The cleaning sequence is thus to be defined for the fabric sheet FS not to come in contact with the pretreatment head 5 or the post-treatment head 6.

As described above, the ink heads 4A to 4H for different colors include upstream heads and downstream heads arranged in the main scanning direction S. For example, the eighth ink heads 4H include the upstream head 4H1 and the downstream head 4H2, which are surrounded by the dotted line indicated as a pair P1. When the fabric-wipe cleaning is performed on the pair P1, the post-treatment head 6 partially overlapping the downstream head 4H2 in the main scanning direction S can be partially covered by the fabric sheet FS. More specifically, the post-treatment liquid comes in contact with the ink.

Thus, the fabric-wipe cleaning is separately performed on the upstream head 4H1, which is at the same position as the post-treatment head 6 in the main scanning direction S. More specifically, the controller 33 controls the carriage drive motor 34 to move the carriage 3 to cause the fabric sheet FS in the wipe portion 7W to face the nozzle surfaces 40 of the upstream head 4H1. The controller 33 then controls the fabric wiper motor 85 to move the fabric wiper 70 in the front-rear direction by the distance corresponding to the width of the upstream head 4H1 in the transport direction F. In the same or a similar manner, the fabric-wipe cleaning is also separately performed on the downstream head 4A2 in the first ink heads 4A, which is at the same position as the pretreatment head 5 in the main scanning direction S. This reduces the likelihood of the pretreatment liquid coming in contact with the ink.

For the other ink heads 4, the fabric-wipe cleaning is performed on one pair for each cleaning operation. For example, the fabric-wipe cleaning is performed on the upstream head 4A1 in the first ink heads 4A and the downstream head 4B2 in the second ink heads 4B as surrounded by the dot line indicated by a pair P2. The controller 33 moves the carriage 3 to cause the fabric sheet FS in the wipe portion 7W to face the area of the pair P2. The controller 33 further moves the fabric wiper 70 in the front-rear direction to cause the fabric sheet FS to move at least between the heads 4B2 and 4A1. The same or a similar operation is performed continuously on the cleaning pair of the upstream head 4G1 in the seventh ink heads 4G and the downstream head 4H2 in the eighth ink heads 4B.

In this manner, the fabric-wipe cleaning may be performed on, as a cleaning unit, each pair of ink heads 4 that eject different colors of ink. In other cases, the fabric-wipe cleaning may be performed sequentially on the ink heads 4 for a specific color. For example, the fabric-wipe cleaning may be performed on the second ink heads 4B and the seventh ink heads 4G alone. In this case, the fabric-wipe cleaning operation is performed first on the upstream head 4B1 and the downstream head 4B2 in the second ink heads 4B that are nearer the left plate 115 on which the fabric wipe device 7 is located. The fabric-wipe cleaning is then again performed on the upstream head 4G1 and the downstream head 4G2 in the seventh ink heads 4G.

### Variation of Embodiment of Fabric Wipe Device

In the above embodiment, the fabric wipe device 7 uses the orientation switch guide 86 having a height difference in the front-rear direction to cause the base 71 to pivot and switch the orientation of the wipe portion 7W. In a variation of the embodiment, the fabric wipe device uses a horizontal guide with no height difference in the front-rear direction as a guide corresponding to the orientation switch guide 86. The horizontal guide is lifted or lowered to cause the base 71 to pivot and switch the orientation of the wipe portion 7W.

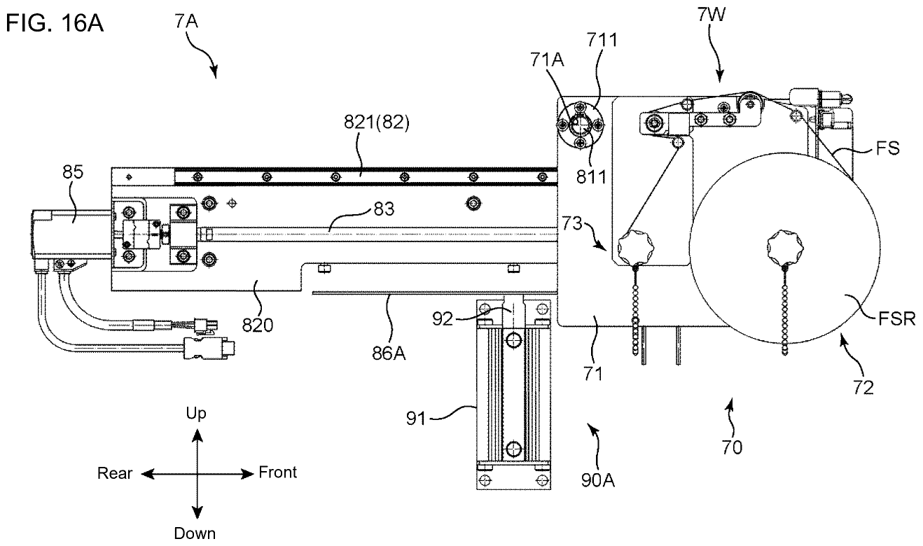

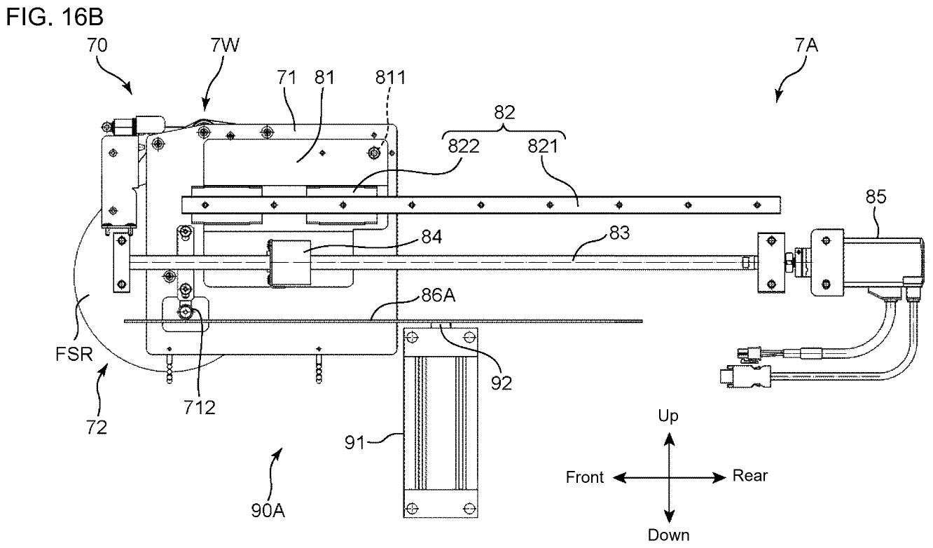

FIGS. 16A and 16B are left and right side views of a fabric wipe device 7A according to a variation of the embodiment, with a fabric wiper 70 in a retracted orientation. The fabric wipe device 7A differs from the fabric wipe device 7 in the example described above in the structure of an orientation switcher 90A that switches the orientation of the wipe portion 7W between the cleaning orientation and the retracted orientation. The other components of the fabric wipe device 7A are the same as or similar to the components of the fabric wipe device 7, and will not be described.

The orientation switcher 90A includes a horizontal guide 86A, a lifter 91, and a pivot structure for the base 71. The pivot structure includes a bearing bush 711, a roller 712, and a pivot pin 811. The base 71 has the same pivot structure as in the above embodiment.

The horizontal guide 86A extends horizontally in the front-rear direction along the linear guide 82. The horizontal guide 86A is a linear guide with no height difference in the front-rear direction. When the movable member 81 moves, the horizontal guide 86A comes in contact with the roller 712 on the base 71. The horizontal guide 86A is not supported in a fixed manner, and can be lifted or lowered while being in contact with the roller 712.

The lifter 91 includes a piston rod 92 drivable to move vertically. The lifter 91 is fixed to the left plate 115 in the apparatus frame 10 at an appropriate position. The lifter 91 may be, for example, one of various cylinder devices such as an air cylinder, a hydraulic cylinder, or an electric cylinder. The piston rod 92 includes its upper end attached to a lower surface of the horizontal guide 86A. The piston rod 92 lifts or lowers the horizontal guide 86A with a pneumatic, hydraulic, or electrical force to allow the horizontal guide 86A to remain in a horizontal orientation while being lifted or lowered. Note that the cylinder device may be replaced with an electric actuator or a lift assembly including a motor and a gear.

In the state in FIGS. 16A and 16B, the piston rod 92 has yet to extend upward. In this state, the horizontal guide 86A is at a lowered position, without the roller 712 being lifted. More specifically, the base 71 and the movable member 81 are in a default state in which the base 71 does not pivot relative to the movable member 81. The base 71 has been moved to the front end of the linear guide 82. More specifically, in the state in FIGS. 16A and 16B, the fabric wiper 70 is at the retracted position at which the fabric wiper 70 does not clean the nozzle placement surface 3A, and the wipe portion 7W is in the retracted orientation in which the wipe portion 7W is separate from the nozzle placement surface 3A.

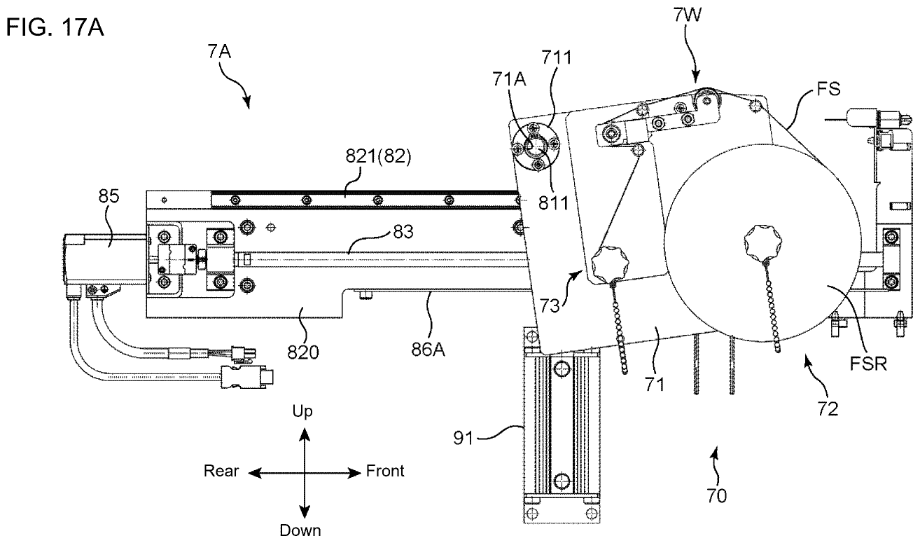

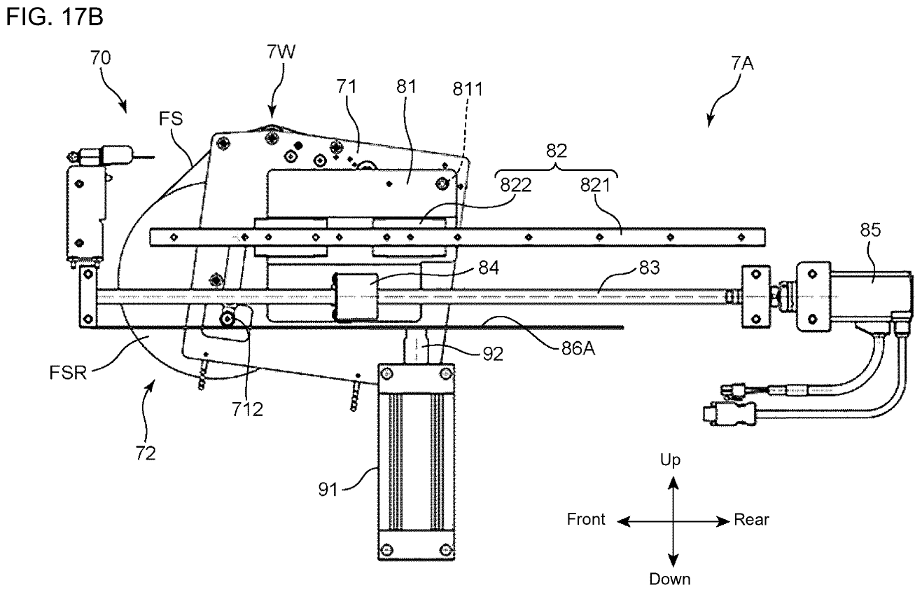

FIGS. 17A and 17B are right and left side views of the fabric wipe device 7A, with the fabric wiper 70 at the cleaning position. The fabric wiper 70 has moved relatively rearward. The piston rod 92 extends upward to lift the horizontal guide 86A to a lifted position. The lifted horizontal guide 86A lifts the roller 712. The base 71 pivots about the bearing bush 711 serving as a pivot and placed through the pivot pin 811 to have the front end of the base 71 being lifted. This pivoting lifts the wipe portion 7W, causing the fabric sheet FS in the wipe portion 7W to switch the cleaning orientation to come in contact with the nozzle placement surface 3A. In this state, the fabric wiper 70 is moved further rearward for fabric-wipe cleaning of the nozzle surfaces 40 of the ink heads 4.

In the variation of the embodiment described above, the position of the wipe portion 7W in the height direction is adjustable. More specifically, the degree by which the piston rod 92 extends is adjusted to adjust the degree of pivoting of the base 71 and thus the height position of the wipe portion 7W. This does not involve precise alignment of the height position of the wipe portion 7W in the cleaning orientation and the height position of the nozzle placement surface 3A. The extent by which the fabric sheet FS in the wipe portion 7W is pressed onto the nozzle placement surface 3A can also be adjusted by the degree by which the piston rod 92 extends.

### Overview

In the present embodiment described above, the inkjet printer 1 can implement the cleaning method for the nozzle placement surface 3A described below.
The fabric wiper 70 includes the wipe portion 7W defined by a portion of the fabric sheet FS between the feeder portion 72 and the takeup portion 73 for the fabric sheet FS.
When the nozzle placement surface 3A is not to be cleaned, the fabric wiper 70 is moved to the retracted position to separate the wipe portion 7W from the nozzle placement surface 3A to place the wipe portion 7W in a standby state.
When the nozzle placement surface 3A is to be cleaned, the fabric wiper 70 is moved to the cleaning position to place the wipe portion 7W in contact with the nozzle placement surface 3A for the fabric-wipe cleaning.

In the present embodiment, the orientation switcher 90 allows the wipe portion 7W to come in contact with the nozzle placement surface 3A in response to the fabric wiper 70 moved to the cleaning position. This structure is noticeably simpler than a structure separately including a device for moving the fabric wiper 70 in the front-rear direction and a device for lifting and lowering the wipe portion 7W. More specifically, the fabric wiper 70 pivots relative to the movable member 81 that moves linearly along the linear guide 82 to switch from the retracted orientation to the cleaning orientation. In other words, the fabric wiper 70 simply mounted on the movable member 81 allows the wipe portion 7W to move and be lifted and lowered without using a drive source for switching the orientation. In the present embodiment, the cleaning device and the cleaning method for a nozzle placement surface can thus be simplest as possible.

1. A cleaning device for a nozzle placement surface on which a nozzle to eject a liquid is placed, the cleaning device comprising:
a fabric wiper including a feeder portion and a takeup portion for a fabric sheet, the fabric wiper further including a wipe portion defined by a portion of the fabric sheet between the feeder portion and the takeup portion;
a mover configured to move the fabric wiper between a cleaning position at which the fabric wiper cleans the nozzle placement surface and a retracted position at which the fabric wiper does not clean the nozzle placement surface; and
an orientation switcher configured to switch an orientation of the wipe portion between a cleaning orientation in which the wipe portion is in contact with the nozzle placement surface at the cleaning position and a retracted orientation in which the wipe portion is separate from the nozzle placement surface at the retracted position.

2. The cleaning device according to claim 1, wherein
the mover includes a linear guide and a movable member movable along the linear guide, and
the fabric wiper is mounted on the movable member to switch between the cleaning orientation and the retracted orientation relative to the movable member.

3. The cleaning device according to claim 2, wherein
the fabric wiper is mounted in a manner pivotable relative to the movable member,
the orientation switcher includes an orientation switch guide extending along the linear guide and configured to come in contact with a contact portion of the fabric wiper when the movable member moves,
the orientation switch guide includes a first portion configured to cause the wipe portion to be in the retracted orientation and a second portion configured to cause the wipe portion to be in the cleaning orientation, and
while the contact portion is in contact with the second portion, the fabric wiper pivots relative to the movable member to place the wipe portion in the cleaning orientation.

4. The cleaning device according to claim 3, wherein
the fabric wiper includes a base to which the feeder portion and the takeup portion are joined,
the base includes
a pivot about which the base pivots relative to the movable member, and
the contact portion located diagonal to the pivot,
the first portion is at a first height and extends in a direction in which the linear guide extends, the second portion is at a second height different from the first height and extends in the direction in which the linear guide extends, and the first portion and the second portion are connected by a slope,
when the contact portion slides on the first portion, the base does not pivot about the pivot and places the wipe portion in the retracted orientation, and
when the contact portion slides on the second portion, the base pivots about the pivot to place the wipe portion in the cleaning orientation.

5. The cleaning device according to claim 1, wherein
the orientation switcher includes
a horizontal guide extending horizontally along the linear guide and configured to come in contact with a contact portion of the fabric wiper when the movable member moves, and
a lifter configured to lift and lower the horizontal guide.

6. The cleaning device according to claim 1, further comprising:
a transport roller configured to feed the fabric sheet from the feeder portion toward the takeup portion through the wide portion; and
a link assembly configured to cause the transport roller to rotate about an axis in response to the fabric wiper switching from the retracted orientation to the cleaning orientation.

7. The cleaning device according to claim 3, further comprising:
a transport roller configured to feed the fabric sheet from the feeder portion toward the takeup portion through the wide portion;
a first gear attached to a rotational shaft of the transport roller; and
a second gear attached to the movable member and meshing with the first gear,
wherein the first gear is configured to rotate to rotate the transport roller about an axis in response to the fabric wiper pivoting relative to the movable member to be in the cleaning orientation.

8. The cleaning device according to claim 6, further comprising:
a one-way clutch configured to rotate the transport roller in a feeding direction of the fabric sheet.

9. The cleaning device according to claim 1, further comprising:
a press roller configured to press the fabric sheet in the wipe portion against the nozzle placement surface; and
a pulley attached to a rotational shaft of the press roller to come in contact with the nozzle placement surface, the pulley being configured to maintain a constant distance between a circumferential surface of the press roller and the nozzle placement surface.

10. The cleaning device according to claim 1, further comprising:
a spray configured to spray a cleaning liquid to a portion of the fabric sheet upstream from the wipe portion.

11. The cleaning device according to claim 1, wherein
the feeder portion is an unwinding roller around which an unused portion of the fabric sheet is wound, and the takeup portion is a winding roller around which a used potion of the fabric sheet is wound, and
the cleaning device further comprises a torque limiter attached to a rotational shaft of the unwinding roller and a torque limiter attached to a rotational shaft of the winding roller.

12. The cleaning device according to claim 11, further comprising:
a transport roller configured to feed the fabric sheet from the feeder portion toward the takeup portion through the wide portion; and
a transmission belt configured to cause the rotational shaft of the winding roller to rotate in response to rotation of a rotational shaft of the transport roller.

13. The cleaning device according to claim 1, wherein
the nozzle placement surface includes nozzles of a pretreatment head for ejecting a pretreatment liquid, a post-treatment head for ejecting a post-treatment liquid, and a plurality of ink heads for ejecting ink,
and
the cleaning device further comprises a cleaning controller configured to define a cleaning sequence to clean the nozzle placement surface with the fabric wiper.

14. A cleaning method for a nozzle placement surface on which a nozzle to eject a liquid is placed, the method comprising:
defining a wipe portion between a feeder portion and a takeup portion for a fabric sheet, the wipe portion being defined by a portion of the fabric sheet;
separating the wipe portion from the nozzle placement surface to place the wipe portion in a standby state when the nozzle placement surface is not to be cleaned; and
placing the wipe portion in contact with the nozzle placement surface for cleaning when the nozzle placement surface is to be cleaned.

15. The cleaning device according to claim 2, further comprising:
a transport roller configured to feed the fabric sheet from the feeder portion toward the takeup portion through the wide portion; and
a link assembly configured to cause the transport roller to rotate about an axis in response to the fabric wiper switching from the retracted orientation to the cleaning orientation.

16. The cleaning device according to claim 4, further comprising:
a transport roller configured to feed the fabric sheet from the feeder portion toward the takeup portion through the wide portion;
a first gear attached to a rotational shaft of the transport roller; and
a second gear attached to the movable member and meshing with the first gear,
wherein the first gear is configured to rotate to rotate the transport roller about an axis in response to the fabric wiper pivoting relative to the movable member to be in the cleaning orientation.
